(19) United States
(12) Patent Application Publication
(10) Pub. No.: US 2025/0134765 A1
(43) Pub. Date: May 1, 2025

(54) JET ASSEMBLY HOUSING TOP, JET ASSEMBLY, AND FLUID PUMP FOR DISPENSING OR EJECTING A FLUID AND A LARGE AMOUNT OF BUBBLES TO A SETTING OR WORK ENVIRONMENT

(71) Applicant: KNH Enterprise, LLC, Gwynn Oak, MD (US)

(72) Inventor: Kiet Q. Huynh, Ellicott City, MD (US)

(73) Assignee: KNH Enterprise, LLC, Gwynn Oak, MD (US)

(21) Appl. No.: 18/384,411

(22) Filed: Oct. 27, 2023

(51) Int. Cl. A61H 33/02

(52) U.S. Cl. CPC A61H 33/027; A61H 33/028

(57) ABSTRACT

One aspect of the present invention is a jet assembly housing top for helping an applicable jet assembly dispense or eject a fluid and a large amount of bubbles to a setting. Another aspect is a jet assembly for dispensing or ejecting a fluid and a large amount of bubbles to a setting. A further aspect is a fluid pump that includes a jet assembly for dispensing or ejecting a fluid and a large amount of bubbles to a setting. Each aspect includes an air tube that draws or pulls in air from outside a setting when in use so that the applicable jet assembly is able to dispense or eject a fluid and a large amount of bubbles to a setting. An embodiment of a jet assembly housing top is a two-piece device comprised of an outer, larger top or cover and an inner, smaller top or cover.

### BACKGROUND OF THE INVENTION

### Field of the Invention

The present invention generally relates to spa devices, components, and systems, jet assembly housing top covers, jet assemblies, and fluid pumps. More specifically, one aspect of the present invention is directed to a jet assembly housing top or cover for helping a jet assembly dispense or eject a fluid and a large amount of bubbles to a setting or work environment. Another aspect of the present invention is directed to a jet assembly for dispensing or ejecting a fluid and a large amount of bubbles to a setting or work environment. A further aspect of the present invention is directed to a fluid pump comprising a jet assembly for dispensing or ejecting a fluid and a large amount of bubbles to a setting or work environment. Each of the aspects of the present invention comprises an air tube or air intake device that allows air outside a setting or work environment to enter or to be drawn or pulled into an applicable jet assembly when in use or operation so that the applicable jet assembly is able to dispense or eject a fluid and a large amount of bubbles to the setting or work environment.

### Description of the Related Art

Spa devices, components, and systems, jet assembly housing top covers, jet assemblies, and fluid pumps are known in the art. Spa devices, jet assembly housing top or covers, jet assemblies, and fluid pumps are used in commercial and recreational settings for hydrotherapy, massage, stimulation, pedicure, and bathing purposes.

There exists a need for a jet assembly housing top or cover (with an air tube or air intake device) for helping a jet assembly dispense or eject a fluid and a large amount of bubbles (preferably an above-average amount compared to the amount dispensed or ejected from many, most or all similar prior art devices, systems, etc.) to a setting or work environment such that the user or customer may further enjoy or may be more satisfied with the visual and/or touch effects (such as, but not limited to, a large amount of bubbles, bubbles of a particular color, or bubbles of multiple colors) provided by the jet assembly and, possibly, also by the cleaning agent(s) that is/are used in the setting or work environment.

Further, there exists a need for a jet assembly (with an air tube or air intake device) for dispensing or ejecting a fluid and a large amount of bubbles (preferably an above average amount compared to the amount dispensed or ejected from many, most or all similar prior art devices, systems, etc.) to a setting or work environment such that the user or customer may further enjoy or may be more satisfied with the visual and/or touch effects (such as, but not limited to, a large amount of bubbles, bubbles of a particular color, or bubbles of multiple colors) provided by the jet assembly and, possibly, also by the cleaning agent(s) that is/are used in the setting or work environment.

In addition, there exists a need for a fluid pump (with a jet assembly that comprises an air tube or air intake device) for dispensing or ejecting a fluid and a large amount of bubbles (preferably an above average amount compared to the amount dispensed or ejected from many, most or all similar prior art devices, systems, etc.) to a setting or work environment such that the user or customer may further enjoy or may be more satisfied with the visual and/or touch effects (such as, but not limited to, a large amount of bubbles, bubbles of a particular color, and/or bubbles of multiple colors) provided by the jet assembly and, possibly, also by the cleaning agent(s) that is/are used in the setting or work environment.

The present invention overcomes one or more of the shortcomings of the above described spa devices, components, and systems, jet assembly housing tops or covers, jet assemblies, and fluid pumps. The Applicant is unaware of inventions or patents, taken either singly or in combination, which are seen to describe the present invention as claimed.

### SUMMARY OF THE INVENTION

One aspect of the present invention is directed to a jet assembly housing top or cover for helping a jet assembly dispense or eject a fluid and a large amount of bubbles to a setting or work environment. Another aspect of the present invention is directed to a jet assembly for dispensing or ejecting a fluid and a large amount of bubbles to a setting or work environment. A further aspect of the present invention is directed to a fluid pump comprising a jet assembly for dispensing or ejecting a fluid and a large amount of bubbles to a setting or work environment. Each of the aspects of the present invention comprises an air tube or air intake device that allows air outside the setting or work environment to enter or to be drawn or pulled into an applicable jet assembly when in use or operation so that the applicable jet assembly is able to dispense or eject a fluid and a large amount of bubbles to the setting or work environment. Further, each of the aspects of the present invention allows for an applicable jet assembly to dispense or eject a fluid and a large amount of bubbles (preferably an above-average amount compared to the amount dispensed or ejected from many, most or all similar prior art devices, systems, etc.) to the setting or work environment such that the user or customer may further enjoy or may be more satisfied with the visual and/or touch effects (such as, but not limited to, a large amount of bubbles, bubbles of a particular color, or bubbles of multiple colors) provided by the jet assembly and, possibly, also by the cleaning agent(s) that is/are used in the setting or work environment.

As an embodiment or non-limiting example of a first aspect of the present invention, the jet assembly housing top or cover is a two-piece device comprised of an outer, larger top or cover and an inner, smaller top or cover. The outer, larger top or cover comprises an air tube or air intake device.

As an embodiment or non-limiting example of a second aspect of the present invention, the jet assembly preferably includes a jet assembly housing, a shaft assembly, an impeller, and an air tube or intake device.

As an embodiment or non-limiting example of a third aspect of the present invention, the fluid pump comprises a jet assembly and a motor or motor assembly. The jet assembly preferably includes a jet assembly housing, a shaft assembly, an impeller, and an air tube or intake device.

As a non-limiting example, the air tube is a detachable air tube. The detachable air tube preferably allows the user or device operator to be able to change the amount of bubbles dispensed or ejected to a setting or work environment for different users or customers. For example, when a large amount of bubbles is/are desired, the detachable air tube is included. However, when normal, average or lesser bubbles is/are desired, the detachable air tube is preferably not included or is covered up partially or completely such that lesser or no air, respectively, can enter or be drawn or pulled into an applicable jet assembly.

### BRIEF DESCRIPTION OF THE DRAWINGS

FIG. 1 is a perspective, top, front view of a two-piece, jet assembly housing top or cover according to the present invention;

FIG. 2 is a perspective, top, rear view of the two-piece, jet assembly housing top or cover of FIG. 1;

FIG. 3 is a front view of the two-piece, jet assembly housing top or cover of FIG. 1;

FIG. 4 is a rear view of the two-piece, jet assembly housing top or cover of FIG. 1;

FIG. 5 is a left side view of the two-piece, jet assembly housing top or cover of FIG. 1;

FIG. 6 is a right side view of the two-piece, jet assembly housing top or cover of FIG. 1;

FIG. 7 is a perspective, top, front view of a jet assembly according to the present invention;

FIG. 8 is a perspective, top, rear view of the jet assembly of FIG. 7;

FIG. 9 is a top view of a two-piece, jet assembly housing top or cover of the jet assembly of FIG. 7;

FIG. 10 is a bottom view of the two-piece, jet assembly housing top or cover of the jet assembly of FIG. 7;

FIG. 11 is a perspective, top, front view of a jet assembly housing bottom or base of the jet assembly of FIG. 7, wherein a shaft assembly and an impeller are secured within the jet assembly housing bottom or base;

FIG. 12 is a perspective, top, rear view of the jet assembly housing bottom or base of the jet assembly of FIG. 7, wherein the shaft assembly and the impeller are secured within the jet assembly housing bottom or base;

FIG. 13 is a front view of the jet assembly housing bottom or base of the jet assembly of FIG. 7, wherein the shaft assembly and the impeller are secured within the jet assembly housing bottom or base;

FIG. 14 is a rear view of the jet assembly housing bottom or base of the jet assembly of FIG. 7, wherein the shaft assembly and the impeller are secured within the jet assembly housing bottom or base;

FIG. 15 is a left side view of the jet assembly housing bottom or base of the jet assembly of FIG. 7, wherein the shaft assembly and the impeller are secured within the jet assembly housing bottom or base;

FIG. 16 is a right side view of the jet assembly housing bottom or base of the jet assembly of FIG. 7, wherein the shaft assembly and the impeller are secured within the jet assembly housing bottom or base;

FIG. 17 is a top view of the jet assembly housing bottom or base of the jet assembly of FIG. 7, wherein the shaft assembly and the impeller are secured within the jet assembly housing bottom or base;

FIG. 18 is a bottom view of the jet assembly housing bottom or base of the jet assembly of FIG. 7, wherein the shaft assembly and the impeller are secured within the jet assembly housing bottom or base;

FIG. 19 is an exploded, perspective, top view of the two-piece, jet assembly housing top or cover of FIG. 1;

FIG. 20 is an exploded, perspective, bottom view of the two-piece, jet assembly housing top or cover of FIG. 1;

FIG. 21 is a top view of the two-piece, jet assembly housing top or cover of FIG. 1, showing an outer, larger top or cover and an inner, smaller top or cover side by side;

FIG. 22 is a front view of the two-piece, jet assembly housing top or cover of FIG. 1, showing the outer, larger top or cover and the inner, smaller top or cover side by side;

FIG. 23 is an environmental view of a fluid pump according to the present invention; and

FIG. 24 is a perspective view of the shaft assembly of the jet assembly of FIG. 7.

It should be understood that the above-attached figures are not intended to limit the scope of the present invention in any way.

### DETAILED DESCRIPTION OF THE PRESENT INVENTION

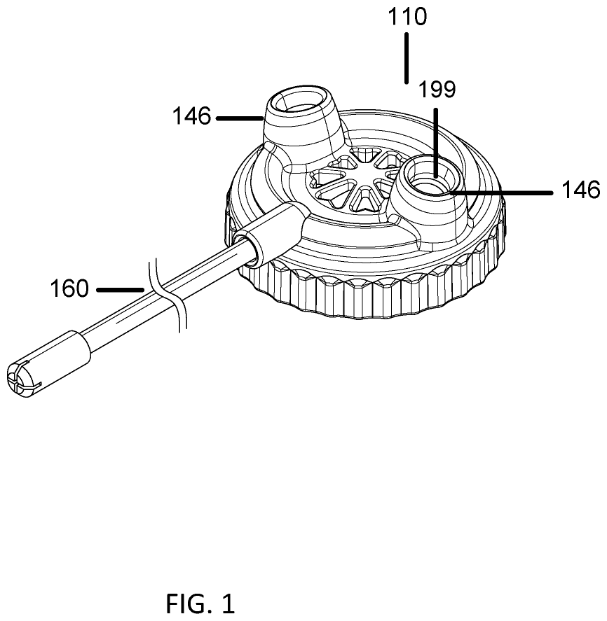

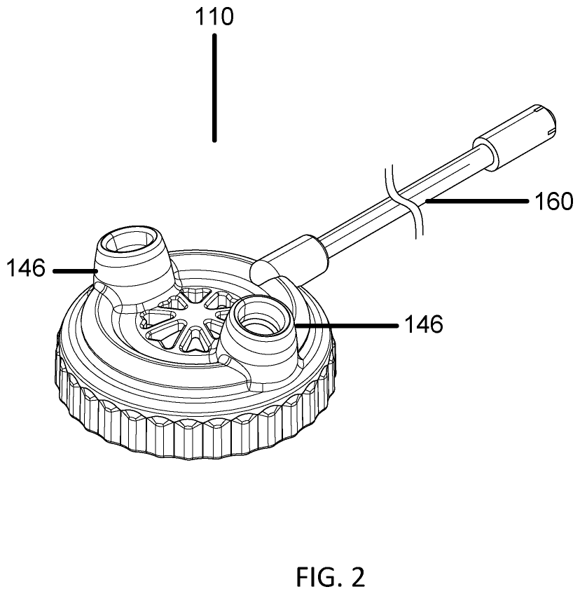

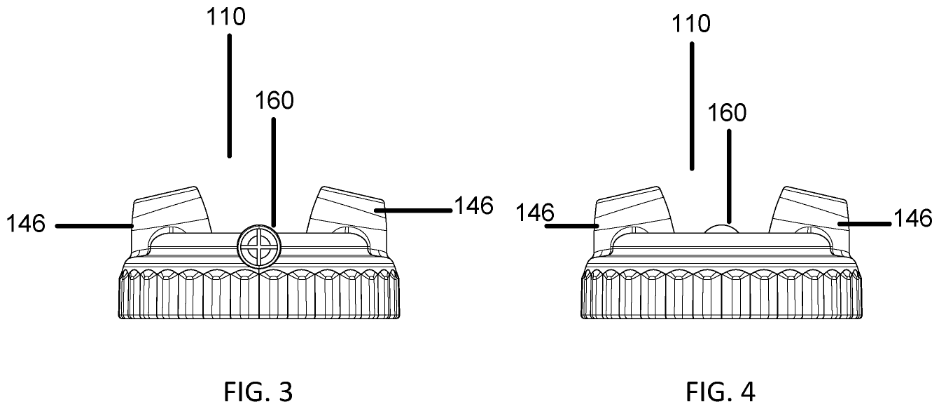

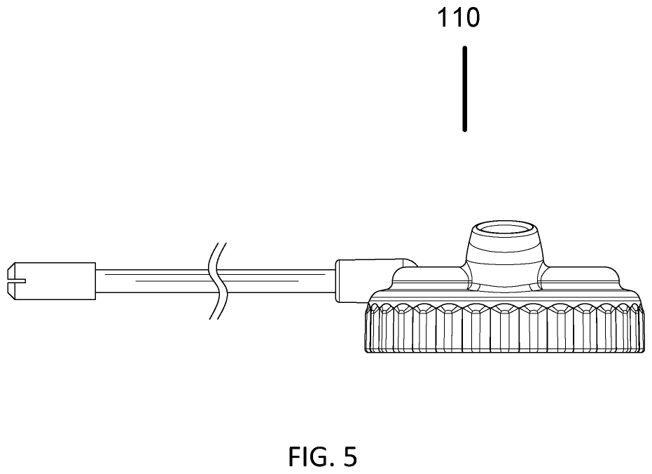

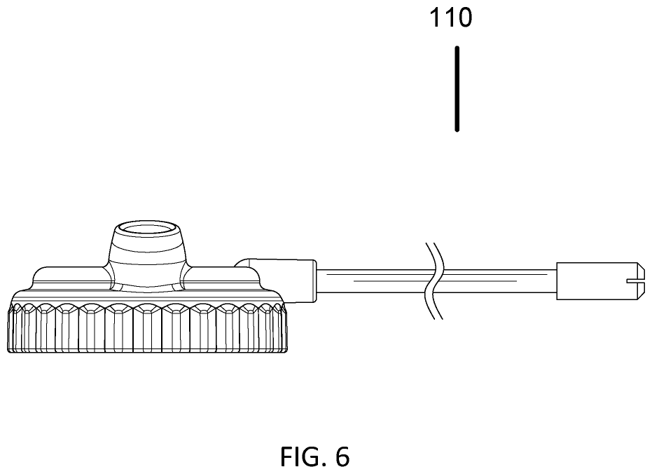

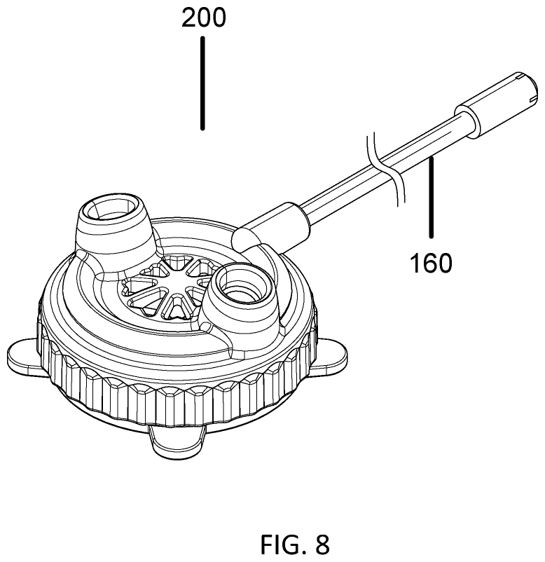

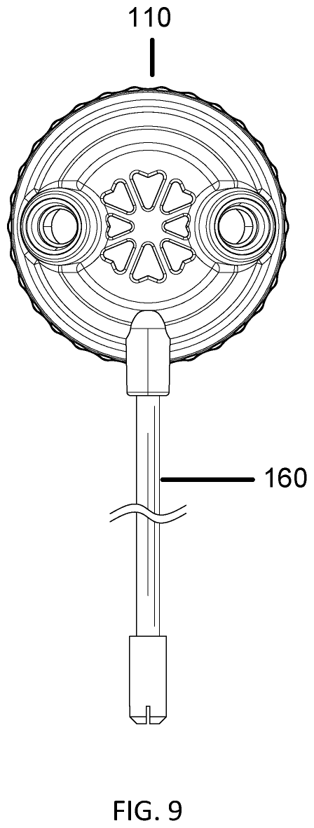

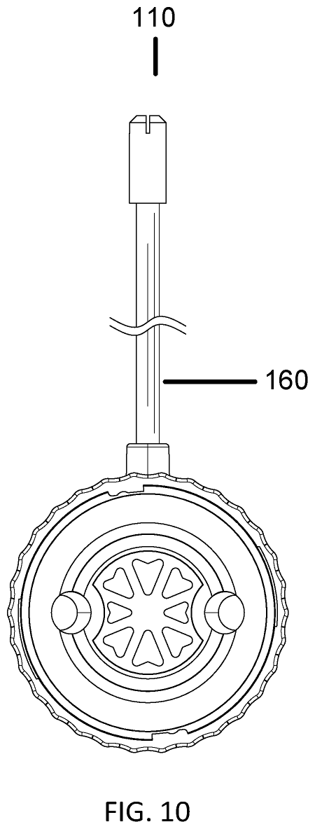

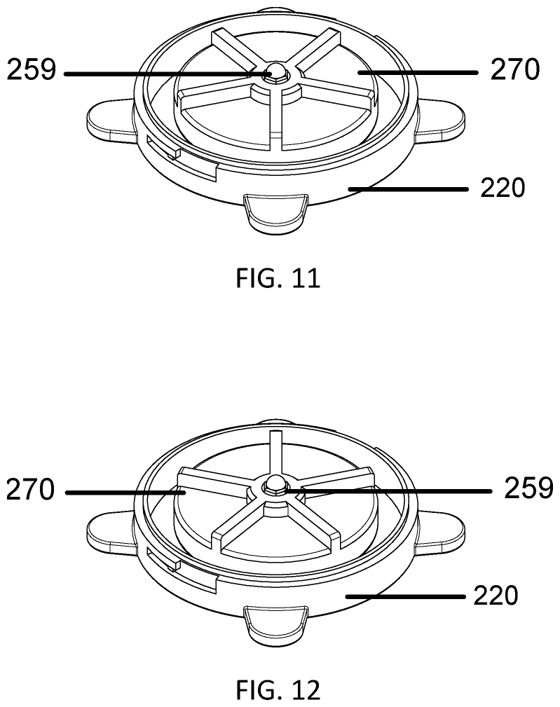

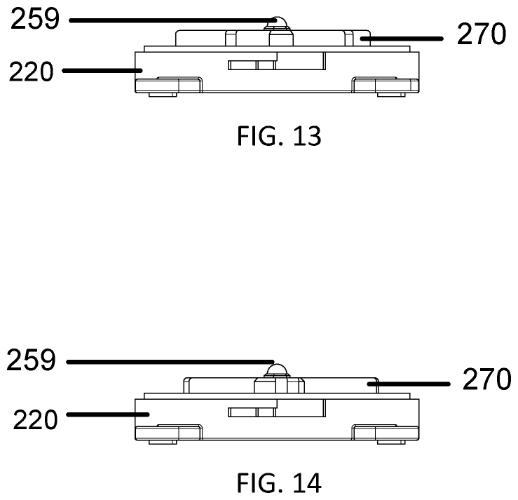

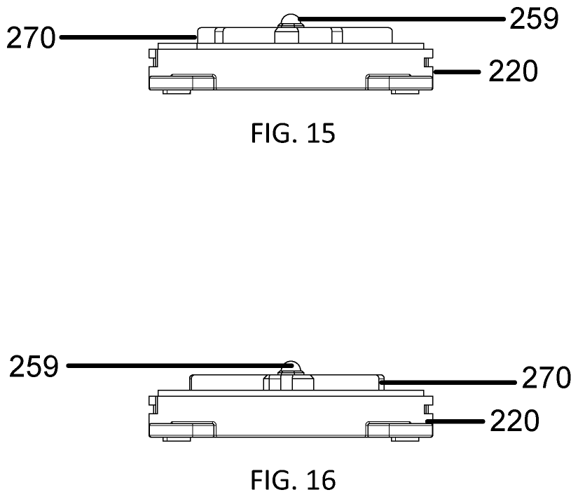

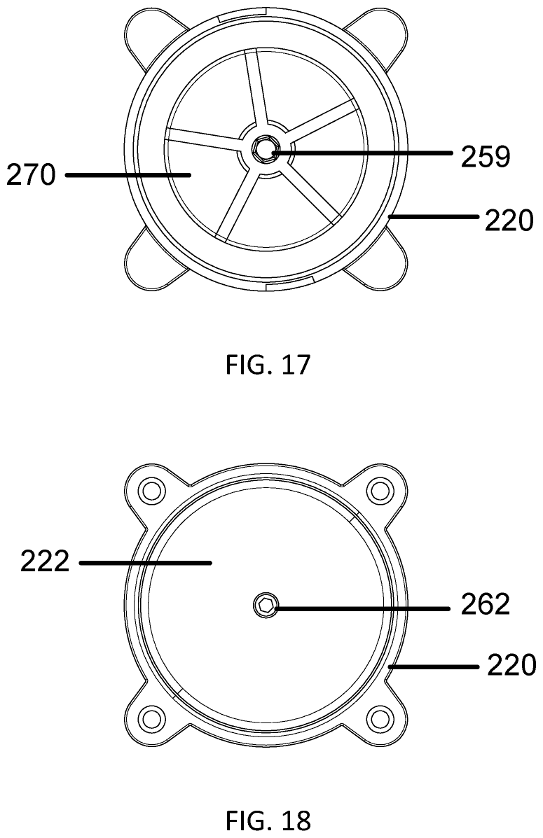

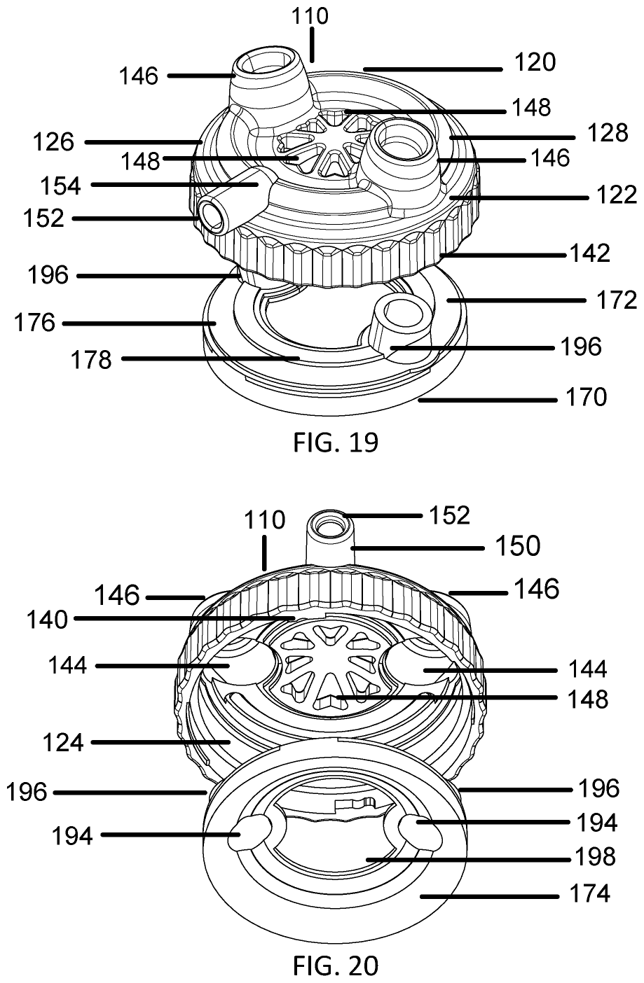

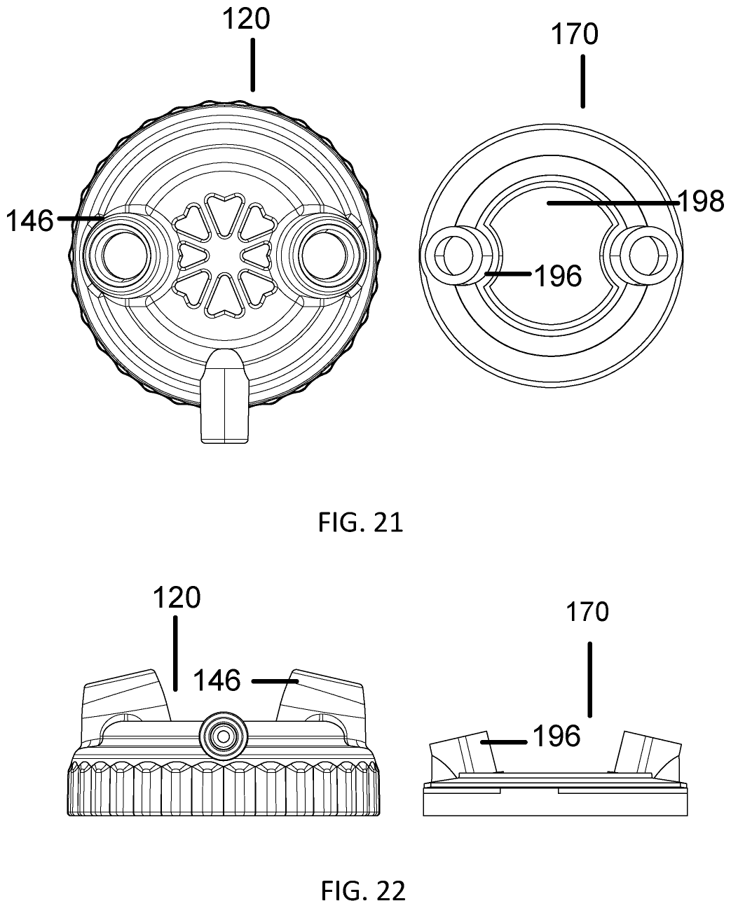

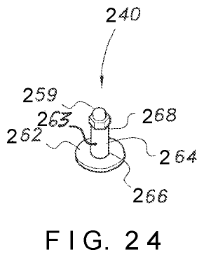

Referring to FIGS. 1-24, one aspect of the present invention is directed to a jet assembly housing top or cover 110 for helping a jet assembly dispense or eject a fluid and a large amount of bubbles to a setting or work environment SET, such as, but not limited, to a foot spa, a spa, a jacuzzi, a bathtub, or a swimming pool. The setting or work environment SET may be preferably be in manicure and pedicure industries and similar industries. Another aspect of the present invention is directed to a jet assembly 200 for dispensing or ejecting a fluid and a large amount of bubbles to a setting or work environment SET. A further aspect of the present invention is directed to a fluid pump 300 comprising a jet assembly 200 for dispensing or ejecting a fluid and a large amount of bubbles to a setting or work environment SET. Each of the aspects of the present invention comprises an air tube or air intake device that allows air outside the setting or work environment to enter or to be drawn or pulled into the applicable jet assembly (specifically, the jet assembly housing) when in use or operation so that the applicable jet assembly is able to dispense or eject a fluid and a large amount of bubbles to the setting or work environment SET. Further, each of the aspects of the present invention allows for an applicable jet assembly to dispense or eject a fluid and a large amount of bubbles (preferably an above-average amount compared to the amount dispensed or ejected from many, most or all similar prior art devices, systems, etc.) to the setting or work environment SET such that the user or customer may further enjoy or may be more satisfied with the visual and/or touch effects (such as, but not limited to, a large amount of bubbles, bubbles of a particular color, or bubbles of multiple colors) provided by the jet assembly and, possibly, also by the cleaning agent(s) that is/are used in the setting or work environment SET.

With regard to the first aspect of the present invention, the jet assembly housing top or cover 110 is adapted for and dimensioned and configured for being secured or detachably secured with an applicable jet assembly housing bottom or base (such as, but not limited to, those in the public domain or the one shown in the drawings of this application) to form a jet assembly housing for usage or operation as a jet assembly, particularly with the inclusion of a shaft assembly and/or an impeller (such as, but not limited to, those in the public domain or the ones shown in the drawings of this application). As a non-limiting example, each of the applicable jet assembly housing bottom or base, shaft assembly and impeller that may operate well, sufficiently, and/or efficiently with the jet assembly housing top or cover 110 may be obtained or purchased from manufacturers and sellers in the related industries or may be made or manufactured as those shown in the drawings and described in the specification of this application. Each of the applicable jet assembly housing bottom or base, shaft assembly and impeller may have multiple versions or embodiments of itself that may operate well, sufficiently, and/or efficiently with the jet assembly housing top or cover 110.

The jet assembly housing top or cover may be made or manufactured as a two-piece device 110 or as a one-piece device (preferably comprising most or all of the components and features of the two-piece device 110).

As best shown in FIGS. 1-6 and 19-23, an embodiment or non-limiting example of the jet assembly housing top or cover 110 is a two-piece device comprised of an outer, larger top or cover 120 and an inner, smaller top or cover 170.

Preferably, the outer, larger top or cover 120 comprises an outer surface 122; an inner surface 124; a perimeter 126; at least one raised ridge or bump 128 (preferably a pair of semi-circular, raised ridges or bumps); a circular wall 130; at least one engagement protrusion 140 (preferably at least two); a gripping element 142 (preferably a plurality of gripping ridges); at least one fluid outlet or aperture 144 (preferably at least two); at least one nozzle 146 (preferably at least two); at least one fluid inlet or aperture 148 (preferably a plurality); an air tube connector 150, and an air tube or intake device 160.

Preferably, the pair of semi-circular, raised ridges or bumps 128 are located on the outer surface 122 and about the perimeter 126. Preferably, at least one raised ridge or bump (preferably, hollow raised ridge or hollow bump) 128 of the pair of semi-circular, raised ridges or bumps 128 help to form an air chamber that connects the air tube connector 150 to the nozzles 146 when the outer, larger top or cover 120 and inner, smaller top or cover 170 are secured to one another. The air chamber (defined by the space or distance gap between the inner surface 124 of the outer, larger top or cover 120 and outer surface 172 of the inner, smaller top or cover 170) has a sufficient diameter to allow the air drawn or pulled from outside the setting or work environment SET through the air tube 160 and air tube connector 150 to flow toward the nozzles 146 and 196 and then be dispensed out of and/or be ejected out of (along with the fluid inside the jet assembly housing, which is composed of the jet assembly housing top or cover 110 and an applicable jet assembly housing bottom or base BASE, 220 secured together) the nozzles 146 (specifically, the nozzle air gaps or spaces 199 that are formed or created between the nozzles 146 and the corresponding nozzles 196 when the outer, larger top or cover 120 and inner, smaller top or cover 170 are secured together) during use or operation. The air chamber and nozzle air gaps or spaces 199 are formed as a result of spaces or distance gaps between the inner surface 124 of the outer, larger top or cover 120 and outer surface 172 of the inner, smaller top or cover 170 when the outer, larger top or cover 120 and inner, smaller top or cover 170 are secured together.

Preferably, the circular wall 130 is located at or about the perimeter 126. The circular wall 130 has an inner surface 132, an outer surface 134, a front or top 136, and a rear or bottom 138.

The engagement protrusions 140 are components adapted for engaging with corresponding engagement components (such as, but not limited to, engagement recesses or grooves) of an applicable jet assembly housing bottom or base BASE such that the jet assembly housing top or cover 110 and jet assembly housing bottom or base BASE may be detachably secured to one another to form a jet assembly housing prior to and during use or operation and also may be detachably unsecured from one another after use or operation for allowing access to the components, maintenance, etc. As a non-limiting example, the engagement protrusions 140 are located on the inner surface 124 and about the perimeter 126.

As a non-limiting example, the plurality of gripping ridges 142 are located on the exterior or outer surface of the circular wall 130. The plurality of gripping ridges 142 preferably allow the user to better grip the jet assembly housing top or cover 110 for securing the jet assembly housing top or cover 110 to the applicable jet assembly housing bottom or base BASE, for detaching or separating the jet assembly housing top or cover 110 from the applicable jet assembly housing bottom or base BASE, for securing the jet assembly to the motor assembly, and for detaching or separating the jet assembly from the motor assembly.

Each of the fluid outlets or apertures 144 has a sufficient diameter to allow the fluid (such as, but not limited to, drawn or pulled from inside the setting or work environment SET through the fluid inlets or apertures 148) and a large amount of bubbles (which result from air drawn from outside the setting or work environment SET through the air tube 160) to flow out of, be dispensed from, and/or be ejected from the jet assembly during use or operation. As a non-limiting example, each of the fluid outlets or apertures 144 is located about the perimeter 126 and on opposing sides of the outer surface 122.

Each of the nozzles 146 has a sufficient diameter to allow the fluid and bubbles to flow out of, be dispensed from, and/or be ejected from the jet assembly during use or operation, and has a sufficient length that enables it and the jet assembly to dispense and/or eject fluid and a large amount of bubbles into the setting or work environment SET during use or operation. Preferably, each of the nozzles 146 extends upwardly or forwardly from the corresponding fluid outlets or apertures 144 and plane of the outer surface 122 such that it has similar longitudinal axis to the longitudinal axis of the circular wall 130. In addition, preferably, each of the nozzles 146 is slightly angled outwardly away from the central area of the outer surface 122 and toward the perimeter 126. As a non-limiting example, the nozzles 146 are located at the different ends of the pair of semi-circular, raised ridges 128.

Each of the fluid inlets or apertures 148 has a sufficient diameter to allow the fluid inside the setting or work environment SET to flow into or to be drawn or pulled into the jet assembly housing during use or operation. As a non-limiting example, the fluid inlets or apertures 148 are located centrally and externally surrounded by the pair of semi-circular, raised ridges 128.

The air tube connector 150 comprises a first end 152, a second end 154, and a sufficient diameter for receiving a second end 164 (or lower end) of the air tube 160 and for allowing air to enter or to be drawn or pulled into the jet assembly housing via the air tube 160 from outside the setting or work environment SET. The first end 144 of the air tube connector 150 is adapted for receiving the second end 164 (or lower end) of the air tube 160. As a non-limiting example, the second end 154 of the air tube connector 150 bisects one semi-circular, raised ridge 128 of the pair of semi-circular, raised ridges 128, and has a longitudinal axis that is about ninety degree) (90° to the longitudinal axes of the nozzles.

The air tube or intake device 160 comprises a first end 162, a second end 164, a body 166 extending from the first end 162 to the second end 164, and a sufficient diameter for allowing air from outside the setting or work environment SET to enter or to be drawn or pulled into the jet assembly during use or operation. The air tube or intake device 160 may also comprise a tip 168 at the first end 162. As a non-limiting example, the air tube 160 is a detachable air tube 160. The detachable air tube 160 preferably allows the user or device operator to be able to change the amount of bubbles for different users. For example, when more or a larger amount of bubbles is/are desired, the jet assembly housing top or cover 110, jet assembly (with the jet assembly housing top or cover 110), and fluid pump (with the jet assembly housing top or cover 110) will include the detachable air tube 160. However, when normal, average or lesser amount of bubbles is/are desired, the jet assembly housing top or cover 110, jet assembly (with the jet assembly housing top or cover 110), and fluid pump (with the jet assembly housing top or cover 110) may or may not include the detachable air tube 160. If the detachable air tube 160 is included, the first end 162 and tip 168 of the detachable air tube 160 are closed off or covered so that air cannot be drawn or pulled into the jet assembly. If the detachable air tube 160 is not included, the first end 152 of the air tube connector 150 is preferably closed off or covered so that fluid cannot be drawn or pulled into the jet assembly through the air tube connector 150.

With regard to the inner, smaller top or cover 170, it has an outer surface 172; an inner surface 174; a perimeter 176; a pair of semi-circular, raised ridges 178; at least one fluid outlet or aperture 194 (preferably at least two); at least one nozzle 196 (preferably at least two); and a centrally-located void or hole 198.

Preferably, the inner, smaller top or cover 170 fits securely with the outer, larger top or cover 120 when they are secured together where nozzles 196 is positioned inside nozzles 146 and where the outer surface 174 of the inner, smaller top or cover 170 is adjacent to (but preferably having a small gap or distance from) the inner surface 124 of the outer, larger top or cover 120. The outer, larger top or cover 120 and inner, smaller top or cover 170 may be secured to one another by secure contact fitting, glue, or any other method or product known to one of ordinary skill in the art.

Preferably, the pair of semi-circular, raised ridges 178 are located on the outer surface 172 and adjacent the centrally-located void or hole 198.

Each of the fluid outlets or apertures 194 has a sufficient diameter to allow the fluid (such as, but not limited to, drawn or pulled from inside the setting or work environment SET through the fluid inlets or apertures 148) to flow out of, be dispensed from, and/or be ejected from the jet assembly during use or operation. As a non-limiting example, each of the fluid outlets or apertures 194 is located about the perimeter 176 and on opposing sides of the outer surface 172.

Each of the nozzles 196 has a sufficient diameter to allow the fluid to flow out of, be dispensed from, and/or be ejected from the jet assembly during use or operation, and has a sufficient length that enables it and the jet assembly to dispense and/or eject fluid into the setting or work environment SET during use or operation. Preferably, each of the nozzles 196 extends upwardly or forwardly from the corresponding fluid outlets or apertures 194 and plane of the outer surface 172 such that it has similar longitudinal axis to the longitudinal axis of the circular wall 130 of the outer, larger top or cover 120. In addition, preferably, each of the nozzles 196 is slightly angled outwardly away from the centrally-located void or hole 198 and toward the perimeter 176. As a non-limiting example, the nozzles 196 are located at the different ends of the pair of semi-circular, raised ridges 178.

The centrally-located void or hole 198 has a sufficient diameter to allow the fluid inside the setting or work environment SET to flow into or to be drawn or pulled into the jet assembly housing during use or operation. As a non-limiting example, the centrally-located void or hole 198 is located centrally and externally surrounded by the pair of semi-circular, raised ridges 178.

When the jet assembly housing top or cover is made or manufactured as a one-piece device, it is preferred that the one-piece device is substantially similar or exactly the same as the two-piece device 110 being secured to one another.

The top or cover may be made or manufactured of plastic, hard plastic, and/or any other suitable material or combination of materials known to one of ordinary skill in the art.

During use or operation of the first aspect of the present invention, the jet assembly housing top or cover 110 (which comprises an air tube or air intake device 160, wherein the upper or top end of the air tube or air intake device 160 is positioned above the fluid level and outside the setting or work environment SET) is secured to an applicable jet assembly housing bottom or base BASE to form or construct a jet assembly housing. The jet assembly housing, preferably along with an applicable shaft assembly and an applicable impeller (preferably a magnetic impeller), are secured (by mechanical means, magnetic attraction or power, any means known to one of ordinary skill in the art, and/or any combination thereof) to a motor (which is generally secured to the setting or work environment SET) such that a fluid pump is formed or constructed. When the motor is turned on, the impeller rotates such that fluid inside the setting or work environment SET is moved into and out of the jet assembly housing and air outside the setting or work environment SET is drawn or pulled into the jet assembly housing whereby the jet assembly is able to dispense or eject a fluid and large amount of bubbles to a setting or work environment SET.

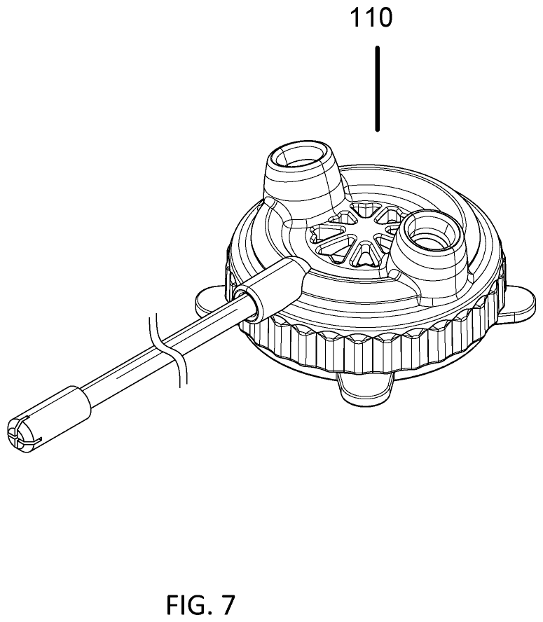

Another aspect of the present invention is directed to a jet assembly for dispensing or ejecting a fluid and large amount of bubbles to a setting or work environment SET. As a non-limiting example and as best shown in FIGS. 7-22, the jet assembly 200 preferably includes: a jet assembly housing 201; a shaft assembly 240; an impeller 270; and an air tube or intake device.

Preferably, the jet assembly housing 201 comprises a jet assembly housing top or cover; a jet assembly housing bottom or base 220; an impeller-receiving chamber 284 defined by the top or cover and bottom or base 220 when secured together; and the air tube or intake device.

Preferably, the jet assembly housing top or cover of the jet assembly housing 201 is the jet assembly housing top or cover 110 with the air tube or intake device 160. Alternatively, the jet assembly housing top or cover of the jet assembly housing 201 may be other jet assembly housing tops or covers that are in the public domain or are known to one of ordinary skill in the art. When this is the case, the air tube or intake device (or another air intake device or air intake method) of the jet assembly 200 may have to be implemented with the jet assembly housing 201 to be able to carry out the use or operation of the present invention.

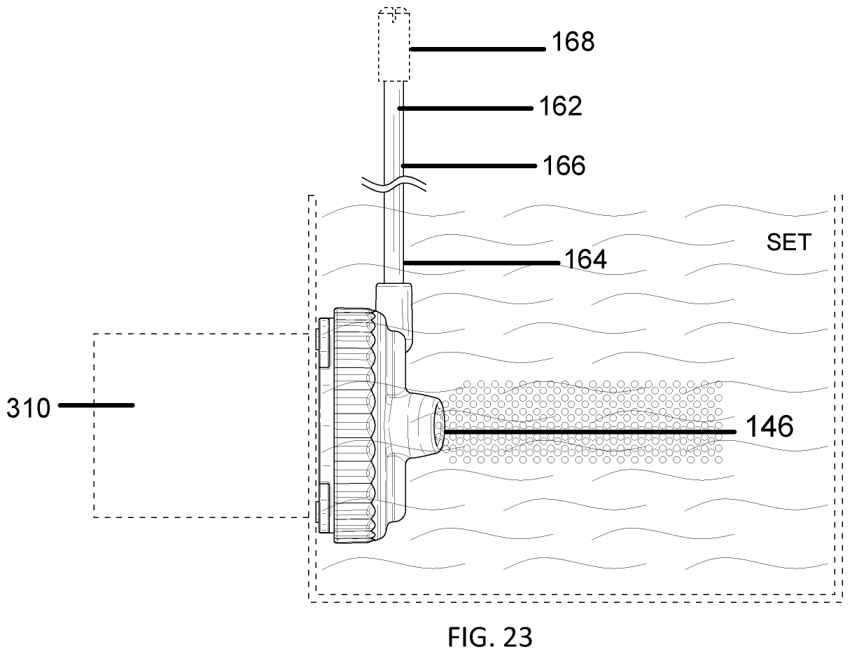

As best shown in FIGS. 11-18, the jet assembly housing bottom or base 220 preferably has an outer surface 222, an inner surface 224, a circular wall 240 at or about the perimeter 226 of the base 220, a plurality of feet extensions 228, and a plurality of engagement recesses or grooves 232. Preferably, the outer surface 222 is generally flat or is planar. The circular wall 240 has an outer surface 242, an inner surface 244, a front or top 246, and a rear or bottom 248. Each of the plurality of feet extensions 228 extends outwardly from about the rear or bottom 248 of the circular wall 240, and has a knob 229 extending rearwardly or downwardly from the corresponding feet extension 228 for engaging with a mounting housing member (not shown) or top of a motor (shown in FIG. 23). Each of the plurality of engagement recesses or grooves 232 is positioned at a predetermined location about the outer surface 242 of the circular wall for engaging with and securing the top or cover 110. The bottom or base 220 may be made or manufactured of plastic, hard plastic, and/or any other suitable material known to one of ordinary skill in the art.

As shown in FIGS. 11-18 and 24, the shaft assembly 240 includes a shaft member 260 and, preferably, a locking mechanism 259.

The shaft member 260 includes a base 262 and a cylindrical body 264 extending upwardly from the base 262. The cylindrical body 264 has a first end 266 and a second end 268. As best shown in FIGS. 11-18, the shaft member 260 is secured, attached, fixed or mounted within the jet assembly housing 201, preferably in a central location of the bottom or base 220 of the housing 201, of the jet assembly 200 via the base 262 of the shaft member 260 being secured, attached, fixed or mounted to the base 220 of the housing 201. The cylindrical body 264 has a first end 266 and a second end 268. The shaft member 260 is preferably made or manufactured of steel or a metal material. It is obvious to one of ordinary skill in the art that other suitable materials may be used in the making or manufacturing of the shaft member 260. Also, the shaft member 260 is preferably made or manufactured as a single piece. It is obvious to one of ordinary skill in the art that the shaft member 260 may be made or manufactured as multiple pieces.

As shown in FIGS. 11-17, the impeller 270, preferably a magnetic impeller 270 and more preferably a planar magnetic impeller 270, has an outer diameter and a “disc-like” configuration or shape, and includes a front side 272, a rear side 274, a sidewall 276, a circular array of arm members 278 positioned on the front side 272, and the centrally-located cavity 279 dimensioned and configured for receiving the shaft member 260 and possibly bearings, etc. (not shown). The centrally-located cavity 279 preferably extends from the front side 272 through to the rear side 274. The magnetic impeller 270 is configured to rotate about the shaft member 260 and to rotate within the impeller-receiving chamber 284. As a non-limiting example, the magnetic impeller 270 may contain a magnetic plate (not shown) within an exterior made or manufactured of rubber or a rubber-like material. It is obvious to one of ordinary skill in the art that the magnetic impeller 270 may be other types of magnetic impellers that is know in the art.

During use or operation of the second aspect of the present invention, the jet assembly 200 (which comprises an air tube or air intake device, such as, but not limited to air tube 160, and preferably also comprises an applicable shaft assembly and an applicable impeller (preferably a magnetic impeller)), is secured (by mechanical means, magnetic attraction or power, any means known to one of ordinary skill in the art, and/or any combination thereof) to a motor or motor assembly (which is generally secured to the setting or work environment SET) such that a fluid pump is formed or constructed. When the motor is turned on, the impeller rotates such that fluid inside the setting or work environment SET is moved into and out of the jet assembly housing and air outside the setting or work environment SET is drawn or pulled into the jet assembly housing via the air tube 160 whereby the jet assembly is able to dispense or eject a fluid and large amount of bubbles to a setting or work environment SET.

A further aspect of the present invention is shown in FIG. 23 and directed to a fluid pump 300 comprising a jet assembly and a motor (or motor assembly) 310.

Preferably, the jet assembly of this fluid pump 300 is jet assembly 200 that preferably includes: a jet assembly housing 201; a shaft assembly 240; an impeller 270; and an air tube or intake device.

Preferably, the jet assembly housing top or cover of the jet assembly housing 201 is the jet assembly housing top or cover 110 with the air tube or intake device 160. Alternatively, the jet assembly housing top or cover of the jet assembly housing 201 may be other jet assembly housing tops or covers that are in the public domain or are known to one of ordinary skill in the art. When this is the case, the air tube or intake device (or another air intake device or air intake method) of the jet assembly 200 may have to be implemented with the jet assembly housing 201 to be able to carry out the use or operation of the present invention.

The motor (or motor assembly) 310 may be any applicable motor or motor assembly known to one of ordinary skill in the art. The motor (or motor assembly) 310 may include and/or be coupled to a power source (not shown) that enables rotation of the motor shaft member (not shown) and magnetic impeller 270.

As best shown in FIG. 23, the jet assembly 200 (which comprises an air tube or air intake device, such as, but not limited to air tube 160, and preferably also comprises an applicable shaft assembly and an applicable impeller (preferably a magnetic impeller)), may be secured to the motor (or motor assembly) 310 (which is generally secured to the setting or work environment SET) by mechanical means, magnetic attraction or power, any means known to one of ordinary skill in the art, and/or any combination thereof.

During use or operation of the third aspect of the present invention, when the motor 310 is turned on, the impeller 270 rotates such that fluid inside the setting or work environment SET is moved into and out of the jet assembly housing 201 and air outside the setting or work environment SET is drawn or pulled into the jet assembly housing 201 via the air tube 160 whereby the jet assembly 200 is able to dispense or eject a fluid and large amount of bubbles to a setting or work environment SET.

It is to be understood that the present invention is not limited to the embodiments described above or as shown in the attached figures, but encompasses any and all embodiments within the spirit of the invention.

1. A jet assembly housing top or cover adapted for engaging with an environmental jet assembly housing bottom or base to form a jet assembly housing for dispensing or ejecting a fluid and a large amount of bubbles to a setting or work environment, said jet assembly housing top or cover comprising:
a top or cover comprising an outer surface, an inner surface, a perimeter, at least one fluid outlet or aperture, at least one fluid inlet or aperture, an air tube connector, and an air chamber,
wherein each of said at least one fluid outlet or aperture comprises a sufficient diameter to allow the fluid and the large amount of bubbles to flow out of, be dispensed from, and/or be ejected from the jet assembly during use or operation,
wherein each of said at least one fluid inlet or aperture comprises a sufficient diameter to allow the fluid inside the setting or work environment to flow into or to be drawn or pulled into the jet assembly housing during use or operation,
wherein said air tube connector is dimensioned and configured for securing an air intake device, and
wherein said air chamber extends from said air tube connector to said at least one fluid outlet or aperture; and
said air intake device comprising a first end, a second end, a body extending from said first end to said second end, and a sufficient diameter for allowing air from outside the setting or work environment to enter or to be drawn or pulled into said air chamber during use or operation.

2. The jet assembly housing top or cover according to claim 1, wherein said top or cover further comprises at least one base engagement element adapted for engaging with the environmental jet assembly housing bottom or base to form the jet assembly for use or operation.

3. The jet assembly housing top or cover according to claim 1, wherein said top or cover further comprises at least one nozzle, wherein each of said at least one nozzle comprises a sufficient diameter to allow the fluid and the bubbles to flow out of, be dispensed from, and/or be ejected from the jet assembly during use or operation, wherein each of said at least one nozzle further comprises a sufficient length that enables it and the jet assembly to dispense and/or eject fluid and the bubbles into the setting or work environment during use or operation, and wherein each of said at least one nozzle extends upwardly or forwardly from a corresponding fluid outlet or aperture of said at least one fluid outlet or aperture and plane of said outer surface.

4. The jet assembly housing top or cover according to claim 1, wherein said top or cover further comprises a circular wall extending downwardly or rearwardly from said outer surface.

5. The jet assembly housing top or cover according to claim 4, wherein said top or cover further comprises at least one nozzle, at least one raised ridge, a gripping element, and at least one base engagement element, and wherein said at least one base engagement element is adapted for engaging with the environmental jet assembly housing bottom or base to form the jet assembly during use or operation, wherein each of said at least one nozzle comprises a sufficient diameter to allow the fluid and the bubbles to flow out of, be dispensed from, and/or be ejected from the jet assembly during use or operation, wherein each of said at least one nozzle further comprises a sufficient length that enables it and the jet assembly to dispense and/or eject fluid and the bubbles into the setting or work environment during use or operation, and wherein each of said at least one nozzle extends upwardly or forwardly from a corresponding fluid outlet or aperture of said at least one fluid outlet or aperture and plane of said outer surface.

6. The jet assembly housing top or cover according to claim 1,
wherein said top or cover is a two-piece, top or cover comprising an outer, larger top or cover and an inner, smaller top or cover,
wherein said outer, larger top or cover comprises an outer surface, an inner surface, a perimeter, at least one fluid outlet or aperture, at least one nozzle, at least one fluid inlet or aperture, and an air tube connector,
wherein said inner, smaller top or cover comprises an outer surface, an inner surface, a perimeter, at least one fluid outlet or aperture, at least one nozzle, and at least one fluid inlet or aperture,
wherein said air chamber is a space defined between said inner surface of said outer, larger top or cover and said outer surface of said inner, smaller top or cover when said outer, larger top or cover and said inner, smaller top or cover are secured to one another for use or operation,
wherein said at least one nozzle of said outer, larger top or cover comprises a sufficient diameter to allow the fluid and the bubbles to flow out of, be dispensed from, and/or be ejected from the jet assembly during use or operation,
wherein each of said at least one nozzle of said outer, larger top or cover further comprises a sufficient length that enables it and the jet assembly to dispense and/or eject fluid and the bubbles into the setting or work environment during use or operation,
wherein each of said at least one nozzle of said outer, larger top or cover extends upwardly or forwardly from a corresponding fluid outlet or aperture of said at least one fluid outlet or aperture of said outer, larger top or cover and plane of said outer surface of said outer, larger top or cover,
wherein said at least one nozzle of said inner, smaller top or cover comprises a sufficient diameter to allow the fluid to flow out of, be dispensed from, and/or be ejected from the jet assembly during use or operation,
wherein each of said at least one nozzle of said inner, smaller top or cover further comprises a sufficient length that enables it and the jet assembly to dispense and/or eject fluid into the setting or work environment during use or operation,
wherein each of said at least one nozzle of said inner, smaller top or cover extends upwardly or forwardly from a corresponding fluid outlet or aperture of said at least one fluid outlet or aperture of said inner, smaller top or cover and plane of said outer surface of said inner, smaller top or cover,
wherein each of at least one nozzle air gap or space is defined between said at least one nozzle of said outer, larger top or cover and a corresponding nozzle of said at least one nozzle of said inner, smaller top or cover when said outer, larger top or cover and said inner, smaller top or cover are secured together for use or operation,
wherein each of said at least one fluid outlet or aperture of said outer, larger top or cover comprises a sufficient diameter to allow the fluid and the large amount of bubbles to flow out of, be dispensed from, and/or be ejected from the jet assembly during use or operation,
wherein each of said at least one fluid inlet or aperture of said outer, larger top or cover comprises a sufficient diameter to allow the fluid inside the setting or work environment to flow into or to be drawn or pulled into the jet assembly housing during use or operation,
wherein said air tube connector of said outer, larger top or cover is dimensioned and configured for securing an air intake device,
wherein each of said at least one fluid outlet or aperture of said inner, smaller top or cover comprises a sufficient diameter to allow the fluid to flow out of, be dispensed from, and/or be ejected from the jet assembly during use or operation, and
wherein each of said at least one fluid inlet or aperture of said inner, smaller top or cover comprises a sufficient diameter to allow the fluid inside the setting or work environment to flow into or to be drawn or pulled into the jet assembly housing during use or operation.

7. The jet assembly housing top or cover according to claim 6, wherein said outer, larger top or cover further comprises at least one base engagement element adapted for engaging with the environmental jet assembly housing bottom or base to form the jet assembly for use or operation.

8. The jet assembly housing top or cover according to claim 6, wherein said outer, larger top or cover further comprises a circular wall extending downwardly or rearwardly from said outer surface of said outer, larger top or cover.

9. The jet assembly housing top or cover according to claim 8, wherein said outer, larger top or cover further comprises at least one raised ridge, a gripping element, and at least one base engagement element, wherein said at least one base engagement element is adapted for engaging with the environmental jet assembly housing bottom or base to form the jet assembly for use or operation.

10. A jet assembly for dispensing or ejecting a fluid and a large amount of bubbles to a setting or work environment, said jet assembly comprising:
a jet assembly housing top or cover comprising an outer surface, an inner surface, a perimeter, at least one fluid outlet or aperture, at least one fluid inlet or aperture, an air tube connector, and an air chamber,
wherein each of said at least one fluid outlet or aperture comprises a sufficient diameter to allow the fluid and the large amount of bubbles to flow out of, be dispensed from, and/or be ejected from said jet assembly during use or operation,
wherein each of said at least one fluid inlet or aperture comprises a sufficient diameter to allow the fluid inside the setting or work environment to flow into or to be drawn or pulled into said jet assembly during use or operation,
wherein said air tube connector is dimensioned and configured for securing an air intake device, and
wherein said air chamber extends from said air tube connector to said at least one fluid outlet or aperture of said jet assembly housing top or cover;
a jet assembly housing bottom or base comprising an outer surface, an inner surface, and a perimeter,
wherein said jet assembly housing bottom or base is adapted for being secured with said jet assembly housing top or cover to form said jet assembly; and
said air intake device comprising a first end, a second end, a body extending from said first end to said second end, and a sufficient diameter for allowing air from outside the setting or work environment to enter or to be drawn or pulled into said air chamber during use or operation.

11. The jet assembly according to claim 10, wherein said jet assembly housing bottom or base further comprises an impeller-receiving chamber defined by said jet assembly housing top or cover and said jet assembly housing bottom or base when secured together.

12. The jet assembly according to claim 10, wherein said jet assembly housing top or cover further comprises a circular wall extending downwardly or rearwardly from said outer surface of said jet assembly housing top or cover, and wherein said jet assembly housing bottom or base further comprises a circular wall extending upwardly or forwardly from said outer surface of said jet assembly housing bottom or base.

13. The jet assembly according to claim 10, wherein said jet assembly housing top or cover further comprises at least one engagement element, and wherein said jet assembly housing bottom or base further comprises at least one engagement element for engaging with said at least one engagement element of said jet assembly housing top or cover.

14. The jet assembly according to claim 10, wherein said jet assembly housing bottom or base further comprises at least one foot extension.

15. The jet assembly according to claim 10, wherein said jet assembly housing top or cover further comprises at least one nozzle, wherein each of said at least one nozzle comprises a sufficient diameter to allow the fluid and the bubbles to flow out of, be dispensed from, and/or be ejected from said jet assembly during use or operation, wherein each of said at least one nozzle further comprises a sufficient length that enables it and said jet assembly to dispense and/or eject fluid and the bubbles into the setting or work environment during use or operation, and wherein each of said at least one nozzle extends upwardly or forwardly from a corresponding fluid outlet or aperture of said at least one fluid outlet or aperture and plane of said outer surface of said jet assembly housing top or cover.

16. The jet assembly according to claim 15, wherein said jet assembly housing top or cover further comprises at least one raised ridge, a gripping element, and at least one base engagement element, wherein said jet assembly housing bottom or base further comprises at least one cover engagement element, and wherein said at least one base engagement element is adapted for engaging with said at least one cover engagement element to form said jet assembly for use or operation.

17. The jet assembly according to claim 10,
wherein said jet assembly housing top or cover is a two-piece, top or cover comprising an outer, larger top or cover and an inner, smaller top or cover,
wherein said outer, larger top or cover comprises an outer surface, an inner surface, a perimeter, at least one fluid outlet or aperture, at least one nozzle, at least one fluid inlet or aperture, and an air tube connector,
wherein said inner, smaller top or cover comprises an outer surface, an inner surface, a perimeter, at least one fluid outlet or aperture, at least one nozzle, and at least one fluid inlet or aperture,
wherein said air chamber is a space defined between said inner surface of said outer, larger top or cover and said outer surface of said inner, smaller top or cover when said outer, larger top or cover and said inner, smaller top or cover are secured to one another for use or operation,
wherein said at least one nozzle of said outer, larger top or cover comprises a sufficient diameter to allow the fluid and the bubbles to flow out of, be dispensed from, and/or be ejected from the jet assembly during use or operation,
wherein each of said at least one nozzle of said outer, larger top or cover further comprises a sufficient length that enables it and the jet assembly to dispense and/or eject fluid and the bubbles into the setting or work environment during use or operation,
wherein each of said at least one nozzle of said outer, larger top or cover extends upwardly or forwardly from a corresponding fluid outlet or aperture of said at least one fluid outlet or aperture of said outer, larger top or cover and plane of said outer surface of said outer, larger top or cover,
wherein said at least one nozzle of said inner, smaller top or cover comprises a sufficient diameter to allow the fluid to flow out of, be dispensed from, and/or be ejected from the jet assembly during use or operation,
wherein each of said at least one nozzle of said inner, smaller top or cover further comprises a sufficient length that enables it and the jet assembly to dispense and/or eject fluid into the setting or work environment during use or operation,
wherein each of said at least one nozzle of said inner, smaller top or cover extends upwardly or forwardly from a corresponding fluid outlet or aperture of said at least one fluid outlet or aperture of said inner, smaller top or cover and plane of said outer surface of said inner, smaller top or cover,
wherein each of at least one nozzle air gap or space is defined between said at least one nozzle of said outer, larger top or cover and a corresponding nozzle of said at least one nozzle of said inner, smaller top or cover when said outer, larger top or cover and said inner, smaller top or cover are secured together for use or operation,
wherein each of said at least one fluid outlet or aperture of said outer, larger top or cover comprises a sufficient diameter to allow the fluid and the large amount of bubbles to flow out of, be dispensed from, and/or be ejected from the jet assembly during use or operation,
wherein each of said at least one fluid inlet or aperture of said outer, larger top or cover comprises a sufficient diameter to allow the fluid inside the setting or work environment to flow into or to be drawn or pulled into the jet assembly housing during use or operation,
wherein said air tube connector of said outer, larger top or cover is dimensioned and configured for securing an air intake device,
wherein each of said at least one fluid outlet or aperture of said inner, smaller top or cover comprises a sufficient diameter to allow the fluid to flow out of, be dispensed from, and/or be ejected from the jet assembly during use or operation, and
wherein each of said at least one fluid inlet or aperture of said inner, smaller top or cover comprises a sufficient diameter to allow the fluid inside the setting or work environment to flow into or to be drawn or pulled into the jet assembly housing during use or operation.

18. The jet assembly according to claim 10, further comprising a shaft assembly and an impeller.

19. A fluid pump for dispensing or ejecting a fluid and a large amount of bubbles to a setting or work environment, said fluid pump comprising:
a jet assembly comprising a jet assembly housing top or cover and a jet assembly housing bottom or base,
wherein said jet assembly housing top or cover comprises an outer surface, an inner surface, a perimeter, at least one fluid outlet or aperture, at least one fluid inlet or aperture, an air tube connector, and an air chamber,
wherein each of said at least one fluid outlet or aperture comprises a sufficient diameter to allow the fluid and the large amount of bubbles to flow out of, be dispensed from, and/or be ejected from said jet assembly during use or operation,
wherein each of said at least one fluid inlet or aperture comprises a sufficient diameter to allow the fluid inside the setting or work environment to flow into or to be drawn or pulled into said jet assembly during use or operation,
wherein said air tube connector is dimensioned and configured for securing an air intake device, and
wherein said air chamber extends from said air tube connector to said at least one fluid outlet or aperture of said jet assembly housing top or cover,
wherein said jet assembly housing bottom or base comprises an outer surface, an inner surface, and a perimeter,
wherein said jet assembly housing bottom or base is adapted for being secured with said jet assembly housing top or cover to form said jet assembly;
said air intake device comprising a first end, a second end, a body extending from said first end to said second end, and a sufficient diameter for allowing air from outside the setting or work environment to enter or to be drawn or pulled into said air chamber during use or operation; and
a motor assembly comprising a motor.

20. The fluid pump according to claim 19,
wherein said jet assembly housing top or cover is a two-piece, top or cover comprising an outer, larger top or cover and an inner, smaller top or cover,
wherein said outer, larger top or cover comprises an outer surface, an inner surface, a perimeter, at least one fluid outlet or aperture, at least one nozzle, at least one fluid inlet or aperture, and an air tube connector,
wherein said inner, smaller top or cover comprises an outer surface, an inner surface, a perimeter, at least one fluid outlet or aperture, at least one nozzle, and at least one fluid inlet or aperture,
wherein said air chamber is a space defined between said inner surface of said outer, larger top or cover and said outer surface of said inner, smaller top or cover when said outer, larger top or cover and said inner, smaller top or cover are secured to one another for use or operation,
wherein said at least one nozzle of said outer, larger top or cover comprises a sufficient diameter to allow the fluid and the bubbles to flow out of, be dispensed from, and/or be ejected from the jet assembly during use or operation,
wherein each of said at least one nozzle of said outer, larger top or cover further comprises a sufficient length that enables it and the jet assembly to dispense and/or eject fluid and the bubbles into the setting or work environment during use or operation,
wherein each of said at least one nozzle of said outer, larger top or cover extends upwardly or forwardly from a corresponding fluid outlet or aperture of said at least one fluid outlet or aperture of said outer, larger top or cover and plane of said outer surface of said outer, larger top or cover,
wherein said at least one nozzle of said inner, smaller top or cover comprises a sufficient diameter to allow the fluid to flow out of, be dispensed from, and/or be ejected from the jet assembly during use or operation,
wherein each of said at least one nozzle of said inner, smaller top or cover further comprises a sufficient length that enables it and the jet assembly to dispense and/or eject fluid into the setting or work environment during use or operation,
wherein each of said at least one nozzle of said inner, smaller top or cover extends upwardly or forwardly from a corresponding fluid outlet or aperture of said at least one fluid outlet or aperture of said inner, smaller top or cover and plane of said outer surface of said inner, smaller top or cover,
wherein each of at least one nozzle air gap or space is defined between said at least one nozzle of said outer, larger top or cover and a corresponding nozzle of said at least one nozzle of said inner, smaller top or cover when said outer, larger top or cover and said inner, smaller top or cover are secured together for use or operation,
wherein each of said at least one fluid outlet or aperture of said outer, larger top or cover comprises a sufficient diameter to allow the fluid and the large amount of bubbles to flow out of, be dispensed from, and/or be ejected from the jet assembly during use or operation,
wherein each of said at least one fluid inlet or aperture of said outer, larger top or cover comprises a sufficient diameter to allow the fluid inside the setting or work environment to flow into or to be drawn or pulled into the jet assembly housing during use or operation,
wherein said air tube connector of said outer, larger top or cover is dimensioned and configured for securing an air intake device,
wherein each of said at least one fluid outlet or aperture of said inner, smaller top or cover comprises a sufficient diameter to allow the fluid to flow out of, be dispensed from, and/or be ejected from the jet assembly during use or operation, and
wherein each of said at least one fluid inlet or aperture of said inner, smaller top or cover comprises a sufficient diameter to allow the fluid inside the setting or work environment to flow into or to be drawn or pulled into the jet assembly housing during use or operation.
